(19) United States
(12) Patent Application Publication
(10) Pub. No.: US 2006/0221596 A1
(43) Pub. Date: Oct. 5, 2006

(54) Emitting light device of shoes

(76) Inventor: Shu-Chen Chang, Hsin-Tien (TW)

Correspondence Address: Shu-Chen Chang, P.O. Box 166-13, Taipei, 115, TW

(21) Appl. No.: 11/096,178

(22) Filed: Apr. 1, 2005

(51) Int. Cl. F21V 21/08

(52) U.S. Cl. 362/103

(57) ABSTRACT

The present invention is aimed to provide an emitting light device of shoes. Optical fibers and nylon fibers woven into a leaflet luminescent panel exposed on any portion of shoes is electrified by a power source hidden in the shoe heel. The light source (LED or NEC ZIP) transmits light emissions to the ends of the woven fibers with irradiation effects. The emitting light device includes a battery base, PCB, battery, switch, LED or NEC ZIP, heat-shrink sleeve and fabric optic panels. In that, said luminescent panel and fiber optic bundles formed at the first and second end of the fabric optic panel respectively. A heat-shrink sleeve receives said fiber optic bundle and a luminous element at the first and second end respectively. A switch is closed to electrify the PCB and then lights the luminous element finally transmits the light emission to the luminescent panel with irradiation effects.

### BACKGROUND OF THE INVENTION

1. Field of the Invention

The present invention is related to an emitting light device of shoes. Particularly a motor-driven emitting light device set on shoe, after electrification, the device is emitting light.

2. The State of the Prior Arts

In recent years, the luminous element can be installed at the sole, heel, vamp or tongue of shoes. After electrification, the luminous element can be turned on with intermittent irradiation effects. Such as Taiwan Patent no. 501414 “light source driven device of shoes” disclosed. Or an electrical glow stick can be applied to illuminate a guided light such as Taiwan Patent no. 609437 “light tube of shoes” disclosed. Or an electro-luminescent panel can be used to show the luminescence such as Taiwan Patent no. 355264 “illuminating structure of shoes” disclosed. Or a luminescent pane reflects light in the night such as Taiwan Patent no. 340310 “luminescent plate for decorating shoes” disclosed.

The light emissions in the aforesaid Taiwan Patent nos. 501414, 609437,355264 only diffused light in the shape of drowsy spots, hazy sectors or smoky surface, even in the Taiwan Patent no. 340310 the brightness light is not coexist with other stronger light source. So they hardly arouse the attention of most people.

As the Taiwan Patent nos. 501414, 609437 disclosed the emitting light are hardly diffused in the shape of a spotlight to spread halo of light over adjacent area with naked eye see, illuminating an area as Taiwan Patent nos. 501414, 609437 disclosed are smaller than Taiwan Patent nos. 355264, 340310 disclosed. But the electro-luminescent panel of Taiwan Patent no. 355264 has drawback as the power consumption larger than others, and Taiwan Patent no. 340310 has provided a luminescent panel with low light brightness.

### SUMMARY OF THE INVENTION

Accordingly, the primary object of the present invention is to provide an emitting light device of shoes, which has a capacity for illuminating a larger illuminated area with a preferred effect of light and save electricity power. A further object of the present invention is to provide a luminescent panel suitable for decorating on the tongue or any portion of shoes. A new shoe with softness in all the right place, the luminescent panel must be adapted to said right place of shoes. Increased the softness of the material such as polymer to produce the well-designed luminescent panel with waterproof, infiltration proof function so as to extend the luminescent life and intensity of the emitting light device.

Point against the aforesaid drawbacks, as the claim 1 of the present invention claimed an emitting device of shoes comprising:

A battery base, secured to the heel of a shoe;

A battery, secured to any face of the battery base contributing to the efficient supply of power to emit LED light;

Luminous elements, emitting rays of light of mixing primary colors;

A switch, controlling luminous elements to conduct electricity;

A heat-shrink sleeve, the first end of the sleeve fits over the luminous element; and

Fabric optic panel, a plurality of fiber optic fibers form fiber optic bundle at the firs end and then fit in the second end of said heat-shrink sleeve; characterized in that:

The second end of the fabric optic panel spreads up a plurality of fiber optic fibers as a planar face topped with a plurality of nylon fibers woven into it to form a luminescent panel, the luminescent panel can be installed at any portion of shoes, as the luminous elements emit light through fiber optic fibers to the luminescent panel for illuminating.

Or the emitting device of shoes as the claim 2 dependent on claim 1 claimed: A PCB disposed in the battery base having IC installed at the PCB for controlling the effect of emitting light of the luminous elements.

Or the emitting device of shoes as the claim 3 dependent on claim 1 claimed:

The first end of the fabric optic panel divided into several fiber optic bundles and then fit in several heat-shrink sleeves separately with 1-1 correspondence, they are adapted to luminous elements to emit light distributed in the same or different color light emissions.

Or the emitting device of shoes as the claim 4 dependent on claim 1 claimed:

The luminous element is an LED or a luminescent chip.

Embodiments of the present invention will achieve the merits as following:

The emitting device of shoes as the claim 1 claimed, in that, the shoe heel has a preset capacity for receiving battery base while the luminescent panel may be secured to any portion of a shoe by stitching across or gluing to thereof. The optic fiber cable is very soft and flexible, so the fiber optic fibers can conduct electricity through connecting link with the battery base and luminescent panel like electrical cords. For the luminescent panel is woven by fiber optic and nylon fiber, so the luminescent panel becomes very broad and light in weight. The luminescent panel can be installed at and “woven into” any planar faces integral with the shoe cover hardly to form a knotted projecture to distinguish from among any portion of shoes. As the luminous elements emit light, guided through the fiber optic, to illuminate the luminescent panel at night, a funny and warning irradiation effect will be achieved.

As the claim 2 claimed, the IC components set on top of the PCB (printed circuit board) in module form control the luminous elements to shimmer light, ignite light or to illuminate light as the programmed circuit executed different instructions to show warning light, signal light and emergency light.

As the claim 3 claimed, heat-shrink sleeves are corresponding to and fit over fiber optic bundles separately with 1-1 correspondence. They are designed for versatile applications to adapt to a series of luminous elements arranged separately in one-to-one relationship pair, therefore, a luminescent panel may emit the same or different color light emissions.

As the claim 4 claimed, the luminous elements is composed of LED or such as NEC ZIP light-emission chip, so it may save the electricity power, extend lifetime of the emitting device.

### BRIEF DESCRIPTION OF THE DRAWINGS

FIG. 1: an exploded view of the first embodiment of the present invention.

FIG. 2: an assembly view of the first embodiment of the present invention.

FIG. 3: a partial enlarged view of the luminescent panel of the present invention.

FIG. 4: a perspective view of the second embodiment of the present invention, several fabric optic panel 17 distributed separately.

FIG. 5: a perspective view of the third embodiment of the present invention, luminescent panel 17a formed by a plurality of fabric optic panels 17 as a whole one.

FIG. 6: a diagram view of the emitting light device applied to shoe in practice.

FIG. 7: a diagram view of the emitting light device applied to slipper in practice; and

FIG. 8: a diagram view of the emitting light device applied to high heel in practice.

### THE PREFERRED EMBODIMENTS OF THE INVENTION

The description is described according to the appending drawings thereafter.

### The First Embodiment

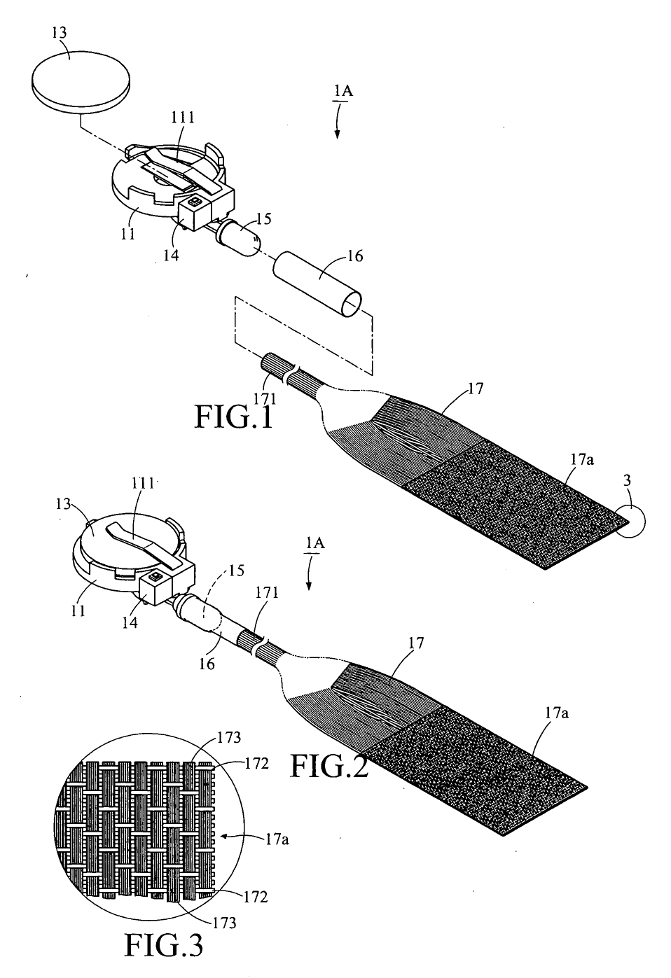

Referring to FIG. 1, an exploded view of the present invention is shown. In that, an emitting light device 1A includes a battery base 11, a battery 13 secured to the battery base 11, a switch 14 added to the battery base 11, a luminous element 15 is served for combination with the battery 13 and the switch 14, the first end of a heat-shrink sleeve 16 is accommodated for the luminous element 15 to fit in, the second end of the heat-shrink sleeve 16 is adapted to fit over luminescent panel 17a of the fabric optic panel 17, the components mentioned above are combined to form an integral emitting light device 1, the assembly view of the present invention is shown as FIG. 2.

As discussed above, the battery 13 disposed in the battery base 11 is secured and clamped by a clip 111. Gathering each one of first end of fiber optic fibers in several bundles and then gluing every first end bundle by adhesive, thus to form several fiber optic bundles 171. Referring to FIG. 3, spread up each of second end of fiber optic fibers and then woven with nylon fibers 173 into a warp and weft knitted fabric, thus to form luminescent panel 17a in the shape of leaflet or leaf-like. Therefore, every heat-shrink sleeves 16 fits over and wraps around fiber optic bundles 171 at second end and wraps up luminous elements 15 at first end separately with 1-1 correspondence. After wrapping or fitting over, the fiber optic bundles 171 are in-line in connection with the luminous elements 15. As the heat-shrink sleeve 16 is shrinkable automatically by heating or warming up, said fiber optic bundles 171 and the luminous elements 15 are to be tied tightly at both ends of the heat-shrink sleeves 16, thus to achieve an anti-fatigue effect to avoid from coming off. Said fabric optic panel 17a is disposed at and secured to any portion of shoes by stitching or gluing. For connecting the luminescent panel 17a with the battery base 11, the length of fiber optic bundles 171 can be elongated appropriately. Aforesaid luminous elements 15 will be a selected one from among LED or such as NEC ZIP luminescent chips. Aforesaid switch 14 is mainly a pressure-sensitive switch includes pushbutton, tiny switch, Digital BCD switch, vibration switch, as FIG. 1 shown is a pushbutton in use.

As mentioned above, after the fiber optic fibers 172 endured light emissions from luminous elements 15, irradiation effects will be occurred to the ends of the end of fabric optic panel 17a. (i.e. ends of fiber optic fibers 172) And the nylon fibers 173 also has some guided light effect. Thus the luminescent panel 17a will be glowing as the light emission guided through the ends of the fiber optic fibers 172. But the luminescent panel 17a has a more staggering light brightness than the ends of fiber optic fibers 172. While selecting different colored nylon fibers (or filament yarns) woven into webbing, a preferred visual effect will be achieved by adapting said fabric optic panel 17a to any portion of shoes.

### The Second Embodiment

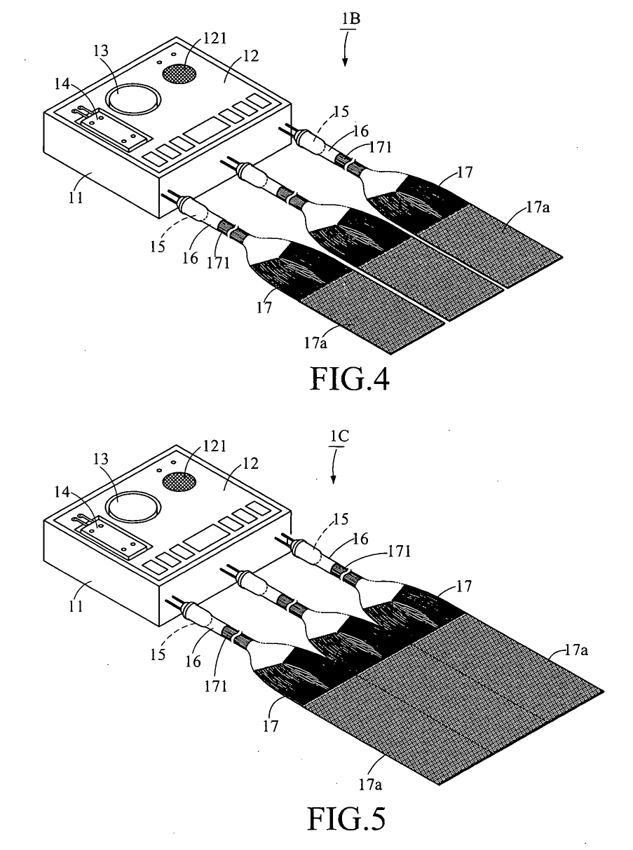

Referring to FIG. 4, the second embodiment of the present invention is shown. An emitting light device 1B includes a battery base 11, a PCB 12 (printed circuit board) and a battery 13 disposed in the battery base 11, a switch 14 added to the battery base 11, a luminous element 15 is accommodated to adapt to the PCB 12, the second end of a heat-shrink sleeve 16 is designed for wrapping around at the first end of the fiber optic bundles 171, the second end of the fiber optic bundles 171 formed as a fabric optic panel 17 of the luminescent panel 17a, and the first end of the heat-shrink sleeve 16 fits over and wraps up the luminous element 15. Moreover, in practice, more than one of the fabric optic panels 17 can be applied to adapt to more than one of the luminous elements 15 and more than one of the heat-shrink sleeves 16 separately with 1-1 correspondence. And the luminous elements 15 can emit light distributed in red, blue, green, yellow, pink, purple and white light color emissions. The luminous elements 15 can be selected from, one or two or more, the same or different colored light emissions. Furthermore, as the FIG. 4 is shown, while vibrating the battery base 11, a vibration switch 14 is driven to conduct electricity to electrify the PCB 12, the IC 121 installed at the PCB 12 may be applied to control the luminous elements 15 to shimmer, to light, or to illuminate in sequence.

### The Third Embodiment

Referring to FIG. 5, the third embodiment of the present invention is shown. In that, an emitting light device 1C is disclosed. The difference between the emitting light device 1C and the aforesaid emitting light device 1B is that the luminescent panel 17a in the third embodiment is composed of a plurality of fabric optic panels 17 formed as a whole one. Every fabric optic panel 17 is accommodated to connect with a luminous element 15 via a heat-shrink sleeve separately with 1-1 correspondence. Moreover, the luminous elements 15 can produce the same or different color light emissions. After electrification of the luminous elements 15, the same luminescent panel 17a will produce a permanent light emission, or different light emissions, or alternate light emissions.

The State of the Present Invention in Practice

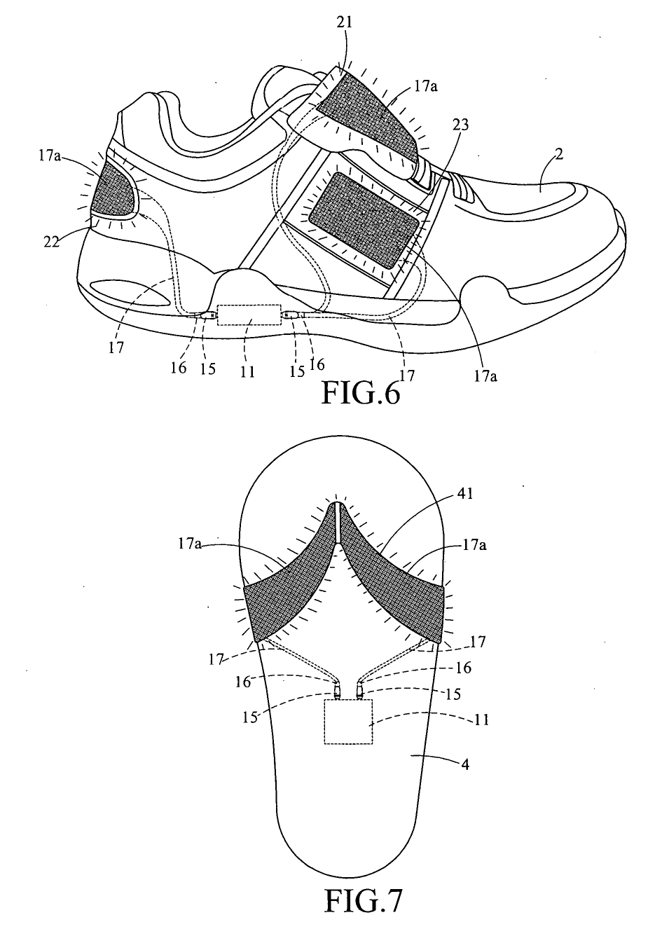

Referring to FIG. 6, a diagram view of the present invention applied to shoes, in that, a preset receptacle in the shoe heel has the capacity for receiving and hiding the battery base 11. By means of the flexible and very soft property of the fabric optic panel 17, the luminescent panel 17a may be drawn up to all the right place of shoes by stitching across or gluing to such as shoe tongue 21, shoe heel 22, shoe vamp or instep 23. A transparent plastic film (not shown, conventional structure) is applied to wrap over the surface of the luminescent panel 17a. More than one luminescent panels 17a may be applied to light at more than one portion of a shoe. The fabric optic panels 17 drawn onto the shoe cover hardly bring any difficulties to the manufacturer, or the users slip-on shoes. As said switch 14 begins to actuate, the luminescent panel 17a will be turned on alternately, the light emissions is controlled by the IC 121, light emissions can be permanent, shimmer, or in turn.

Referring to FIG. 7, a diagram view of the present invention applied to a slipper, in that, said luminescent panels 17a fix on two straps 41 of the slipper or sandal 4, the surface of the luminescent panel 17a is wrapped by a layer of transparent film. (not shown, conventional structure). Moreover, the fabric optic panels 17 for transmitting light emissions to the luminescent panels 17a and the battery base 11 are hidden onboard inside the shoe heel of slipper or sandal 4. After the luminescent panels 17a begin to start the light emissions, two straps 41 of the slipper or sandal 4 will be shimmering or illuminating.

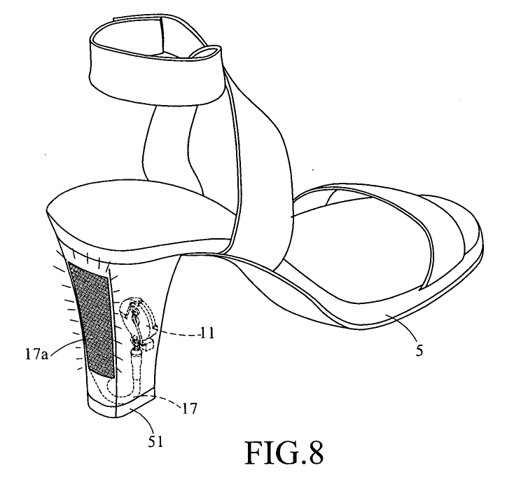

Referring to FIG. 8, a diagram view of the present invention applied to a high heel, in that, battery base 11 and fabric optic panel 17 are hidden in the shoe heel 51 of high heel 5. But the luminescent panel 17a is exposed on the back surface of the shoe heel. A transparent film (not shown, conventional structure) is applied to wrap over the surface of the luminescent panel 17a. As the luminescent panel 17a begins to start the light emission, the shoe heel 51 of the high heel 5 will be illuminating.

What is claim is claimed:

1. An emitting light device of shoes comprising:
A battery base, secured to the heel of a shoe;
A battery, secured to any face of the battery base contributing to the efficient supply of power to emit LED or NEC ZIP light;
Luminous elements, emitting rays of light of mixing primary colors;
A switch, controlling luminous elements to conduct electricity;
A heat-shrink sleeve, the first end of the sleeve fits over the luminous element; and
Fabric optic panel, a plurality of fiber optic fibers form fiber optic bundle at the first end and then fit in the second end of said heat-shrink sleeve; characterized in:
The second end of the fabric optic panel spreads up a plurality of fiber optic fibers as a planar face topped with a plurality of nylon fibers woven into it to form a luminescent panel, the luminescent panel can be installed at any portion of shoes, as the luminous elements emit light through fiber optic fibers to the luminescent panel for illuminating.

2. The emitting device of shoes according to claim 1, in that, a PCB disposed in the battery base having IC installed at the PCB for controlling the effect of emitting light of the luminous elements.

3. The emitting device of shoes according to claim 1, in that, the first end of the fabric optic panel divided into several fiber optic bundles and then fit in several heat-shrink sleeves separately with I-I correspondence, they are adapted to the luminous elements to emit light distributed in the same or different color light emissions.

4. The emitting device of shoes according to claim 1, in that, the luminous element is an LED or an emitting light chip such as NEC ZIP.
